(19) United States
(12) Patent Application Publication
(10) Pub. No.: US 2012/0277976 A1
(43) Pub. Date: Nov. 1, 2012

(54) CIRCUIT ARRANGEMENT FOR VEHICLE ECU

(75) Inventor: Gregory M. Skoff, Dublin, OH (US)

(73) Assignee: HONDA MOTOR CO., LTD., Tokyo (JP)

(21) Appl. No.: 13/098,073

(22) Filed: Apr. 29, 2011

(51) Int. Cl. F02D 41/30; B60L 1/00

(52) U.S. Cl. 701/103; 307/10.1

(57) ABSTRACT

A circuit arrangement includes a vehicle ECU, a plurality of first sensors electrically connected with the ECU in a daisy-chain arrangement, and a plurality of second sensors electrically connected with the ECU in a daisy-chain arrangement. The ECU is configured to control a fuel injection system of a vehicle engine. Each of the plurality of first sensors is configured to operate at a first voltage and to sense a respective vehicle engine condition. Each of the plurality of second sensors is configured to operate at a second voltage, which is different than the first voltage, and to sense a respective vehicle engine condition.

### BACKGROUND

Control units are used are used to receive measurements from sensors, perform calculations and send commands to actuators. A cable harness connects the control units and devices in order to allow information exchange between them. In addition, power and ground need to be distributed from the control unit or elsewhere in the electrical system to the devices so that the devices can operate. It is common for devices to require different voltage levels (for example, 5 volts and 12 volts) for operation.

Today, the cable harness between control units and devices, particularly one used on a modern vehicle engine, is a complex component. A cable is connected directly between the control unit and each sensor on the engine. Additionally, power and ground are distributed to each of the sensors through other cables. In order to reduce the overall cable length, the power and ground distribution is typically accomplished by connecting a single cable between the control unit and a connection hub near the sensors, then connecting multiple cables between the connection hub and each of the sensors. There may be connecting hubs to distribute multiple power voltages and multiple ground locations. All of the sensor cables are joined to the sensor through a connector, but there are many different connector shapes due to the various sensor mating shapes. Finally, because there are many cables in proximity to each other in the cable harness, it is likely that electrical noise will be passed between the cables and affect vehicle function. The complexity of the cable harness increases the difficulty of manufacturing on a large scale and the large number of different components increases the overall cost to build.

With respect to FIG. 1, a vehicle engine control unit (“ECU”) 10 and a plurality of sensors 12-20 are shown. The vehicle ECU 10 monitors the sensors 12-20 that are mounted on a vehicle engine to control a fuel injection system. The vehicle ECU 10 receives data sensed by the sensors 12-20 to control fuel injection valves of the fuel injection system.

The sensors 12-20 mount to the vehicle engine (not shown). Currently, each sensor is directly connected to three circuits, which usually consist of two input circuits, i.e. power and ground, and one output circuit. The output circuit needs to be directly connected between the respective sensor and the ECU 10 so that the ECU can use the sensor signal for control purposes and to drive actuators. Multiple data transmission wires 22 connect the respective sensors directly to the ECU 10. The power and ground circuits are typically connected between all of the sensors via a plurality of separate ground wires 24, a plurality of separate 5-volt power wires 26 and a plurality of separate 12-volt power wires 28.

To minimize total wire length, a single 5-volt power wire 32, a single 12-volt power wire 34 and a ground wire 36 runs from the source, which as shown in FIG. 1 is the ECU 10, to a respective joint connector, which is located on the vehicle engine near the sensors. Since the sensors operate at different voltages a 12-volt joint connector 38 and a 5-volt joint connector 40 are provided. As mentioned above, a ground joint connector 42 is also provided. Each joint connector has multiple outputs where multiple wires are broken up which run to each respective sensor.

The current wire harness structure and circuit arrangement necessitates many wires, which results in a complex assembly process and high material cost. Further, because there are large bundles of individual circuits that are spaced closely together in the wire harness, there is possibility for a circuit to transfer electrical noise to another nearby circuit and interfere with data transmission. Additionally, most of the sensors that are used on the vehicle engine have different types of mating connectors, and because there are many different types of mating connectors, the cost of these parts is high.

### SUMMARY

An example of a circuit arrangement that can overcome at least one of the aforementioned shortcomings includes a vehicle ECU, a plurality of first sensors electrically connected with the ECU in a daisy-chain arrangement, and a plurality of second sensors electrically connected with the ECU in a daisy-chain arrangement. The ECU is configured to control a fuel injection system of a vehicle engine. Each of the plurality of first sensors is configured to operate at a first voltage and to sense a respective vehicle engine condition. Each of the plurality of second sensors is configured to operate at a second voltage, which is different than the first voltage, and to sense a respective vehicle engine condition.

An example of a vehicle system that can overcome at least one of the aforementioned shortcomings includes a vehicle ECU, a first cable, a first sensor, a second cable, a second sensor, a third cable, a third sensor, a fourth cable, and a fourth sensor. The ECU is configured to control a fuel injection system of a vehicle engine. The first cable connects with the ECU. The first sensor also connects with the first cable and is configured to operate at a first voltage and to sense a first vehicle condition. The second cable connects with the first sensor. The second sensor connects with the second cable and is configured to operate at the first voltage and to sense a second vehicle condition. The third cable connects with the ECU. The third sensor connects with the third cable and is configured to operate at a second voltage, which is different than the first voltage, and to sense a third vehicle condition. The fourth cable connects with the third sensor. The fourth sensor connects with the fourth cable and is configured to operate at the second voltage and to sense a fourth vehicle condition. Each cable includes at least two respective signal wires, a respective power wire and a respective ground wire.

A method for providing power and transmitting signals that can overcome at least one of the aforementioned shortcomings includes electrically connecting via a first cable, a first engine sensor to a vehicle ECU; electrically connecting via a second cable, a second engine sensor to the first engine sensor; providing a first voltage to the first sensor via the first cable; providing the first voltage to the second sensor via the first cable, the first sensor and the second sensor; transmitting signals between the first sensor and the ECU via the first cable; transmitting signals between the second sensor and the ECU via the first cable, the first sensor and the second cable; electrically connecting via a third cable a third engine sensor to the ECU; electrically connecting via a fourth cable a fourth engine sensor to the third engine sensor; providing a second voltage, which is different from the first voltage, to the third sensor via the third cable; providing the second voltage to the fourth sensor via the third cable, the third sensor, and the fourth cable; transmitting signals between the third sensor and the ECU via the third cable; and transmitting signals between the fourth sensor and the ECU via the third cable, the third sensor and the fourth cable.

### BRIEF DESCRIPTION OF THE DRAWINGS

FIG. 1 is a schematic depiction of a known circuit arrangement including a vehicle ECU and a plurality of sensors that mount to a vehicle engine.

FIG. 2 is a schematic depiction of a novel circuit arrangement for a vehicle ECU and a plurality of sensors mounted to a vehicle engine.

FIG. 3 is a schematic depiction of another novel circuit arrangement for a vehicle ECU and a plurality of sensors mounted to a vehicle engine.

FIG. 4 is a schematic depiction of a connector for use with the circuit arrangement depicted in FIG. 3.

FIG. 5 is a schematic depiction of a portion of a cable for connecting a respective sensor, such as the sensors depicted in FIG. 2, to the ECU, which is also depicted in FIG. 2.

### DETAILED DESCRIPTION

The description and drawings herein are merely illustrative and various modifications and changes can be made in the structures disclosed without departing from the scope of the appended claims. Identified components of a circuit arrangement described below are merely terms of art that may vary from one vehicle manufacturer to another and should not be deemed to limit the present disclosure or the appended claims.

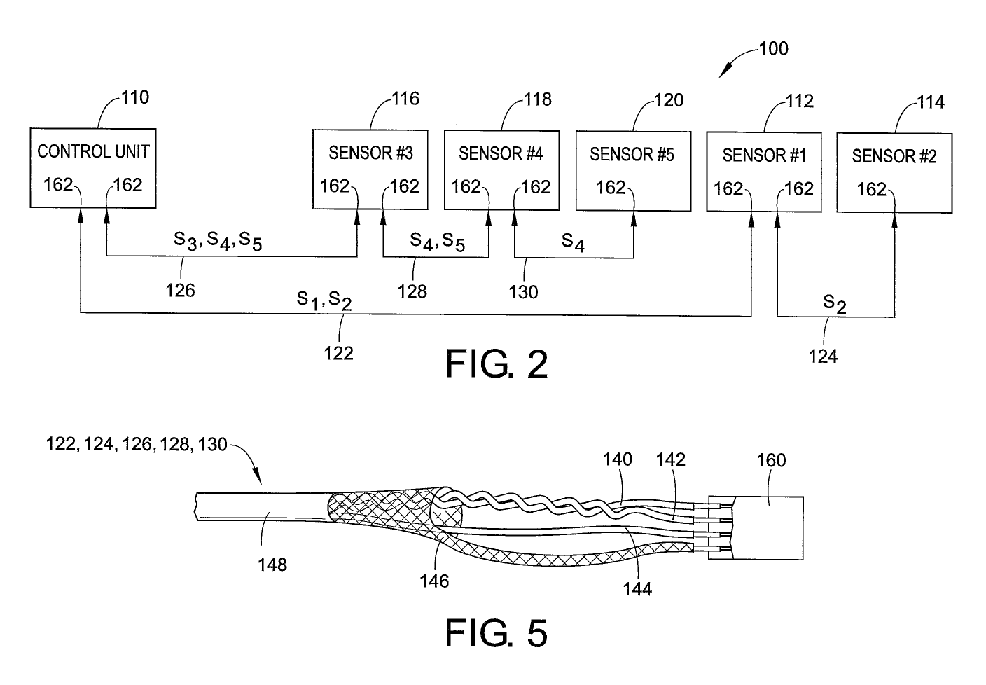

Referring now to the drawings, where like numerals refer to like parts throughout the several views, FIG. 2 schematically depicts a circuit arrangement for vehicle system 100 that includes a control unit 110, which can be a vehicle ECU configured to control a fuel injection system of a vehicle engine. A plurality of first sensors (or other devices) 112, 114 electrically connect with the ECU 110 in a daisy-chain arrangement. A plurality of second sensors (or devices) 116, 118, 120 electrically connect with the ECU 110 also in a daisy-chain arrangement. Each of the plurality of first sensors 112, 114 is configured to operate at a first voltage, which in the depicted embodiment is 12 volts, and to sense a respective vehicle engine condition. For example, the first sensor 112 can be a crank sensor and the second sensor 114 can be a top-dead-center sensor. Each of the plurality of second sensors 116, 118, 120 are configured to operate at a second voltage, which is different than the first voltage, and to sense a respective vehicle condition. In the illustrated embodiment, each of the plurality of second sensors 116, 118, 120 are configured to operate at 5 volts. The third sensor 116 can be a manifold air pressure sensor, the fourth sensor 118 can be is an air/fuel mixture sensor, and the fifth sensor 120 can be a throttle sensor. A fewer or a greater number of sensors can be provided, and each sensor can sense another condition.

With continued reference to FIG. 2, the plurality of first sensors (or other devices) 112, 114 electrically connect with the ECU 110 in a daisy-chain arrangement with respect to power, ground and signal (data) transmission. In FIG. 2, a first cable 122 connects with the ECU 110. The first sensor 112 connects with the first cable 122 and is configured to operate at the first voltage, e.g. 12 volts, and to sense a first vehicle condition, e.g. the first sensor being a crank sensor. A second cable 124 connects with the first sensor 112. The second sensor 114 connects with the second cable 124 and is configured to operate at the first voltage, e.g., 12 volts, and to sense a second vehicle condition, e.g. the second sensor 114 is a top-dead-center sensor.

With reference to FIG. 2, the plurality of second sensors (or devices) 116, 118, 120 electrically connect with the ECU 110 also in a daisy-chain arrangement with respect to power, ground and signal (data) transmission. A third cable 126 connects with the ECU 110. The third sensor 116 connects with the third cable 126 and is configured to operate at the second voltage, which in the depicted embodiment is 5 volts. The third sensor 116 is also configured to sense a third vehicle condition, e.g. the third sensor can be a manifold air pressure sensor. A fourth cable 128 connects with the third sensor 116. The fourth sensor 118 connects with the fourth cable 128 and is configured to operate at the second voltage, e.g., 5 volts, and to sense a fourth vehicle condition. As mentioned above, the fourth sensor 118 can be an air/fuel mixture sensor. A fifth cable 130 connects with the fourth sensor 118. The fifth sensor 120 connects with the fifth cable 130 and is configured to operate at the second voltage, e.g. 5 volts, and to sense a fifth vehicle engine condition. As mentioned above, the fifth sensor 120 can be a throttle sensor.

With reference to FIG. 5, each cable 122, 124, 126, 128, 130 includes at least two respective signal wires 140, 142, a respective power wire 144, and a respective ground wire 146. As seen in FIG. 5, the ground wire 146 surrounds the signal wires, 140, 142 and the power wire 144 along a majority of the length of each cable 122, 124, 126, 128, 130, and a protective sheath 148 also surrounds each of the wires 140, 142, 144 and 146. As discussed above, in known circuit arrangements around vehicle engines large bundles of individual circuits are placed very near one another, and there is a possibility for a circuit to transfer electrical noise to another nearby circuit and to interfere with data transmission. With the ground wire 146 surrounding the signal wires 140, 142, which is where the data transmission occurs in the respective cables, the ground wire 146 acts to shield the signal wires 140, 142 from electrical interference and noise.

The cables 122 and 124 that connect the plurality of first sensors 112, 114 to the ECU 110 can have the same components and configuration as the cables 126, 128, 130 that connect the plurality of second sensors 116, 118, 120 to the ECU. As such, each power wire 144 can be capable of power transmission up to 12 volts.

With continued reference to FIG. 5, each cable 122, 124, 126, 128, 130 includes a respective terminal 160. One terminal 160 at one end of the cable is shown in FIG. 5. Each cable can include a similar terminal at the opposite end of the cable. With reference to FIG. 2, each sensor 112, 114, 116, 118, 120 includes at least one connector 162 (depicted schematically) configured to receive a respective terminal 160 for connecting the respective cable to the respective sensor. The ECU 110 can include similar connectors 162. Each connector 162 is configured to accommodate the at least two respective signal wires 140, 142, the respective power wire 144 and the respective ground wire 146 to allow for power and data transmission between the ECU 110 and the respective sensor. At least one of the sensors in each of the plurality of first sensors 112, 114 and the plurality of second sensors 116, 118, 120 includes a first connector and a second connector. For example, the first sensor 112 includes two connectors, and the third sensor 116 and the fourth sensor 118 also each include two connectors. The second connector in each sensor has an identical configuration to the first connector. The first connector and the second connector are each configured to receive a respective terminal 160 for connecting a respective cable to the respective sensor. Each connector is configured to accommodate the at least two respective signal wires 140, 142, the respective power wire 144 and the respective ground wire 146. By having identical connectors for each of the sensors, one common connector type can be used for each of the sensors which provides for a large amortization volume to reduce the cost of each connector.

With reference back to FIG. 2, the first sensor 112 receives the first voltage, e.g., 12 volts, from the ECU 110 through the first cable 122, and more particularly through the power wire 144 of the first cable. Signals S₁ are transmitted from the first sensor 112 to the ECU 110 through the first cable. Signals can also be transmitted to the first sensor 112 from the ECU 110 through the first cable. The signals travel along the respective signal wires 140, 142 of the first cable 122. The second sensor 114 receives the first voltage, e.g., 12 volts, from the ECU 110 through the first cable 122, the first sensor 112 and the second cable 124. Signals S₂ are transmitted between the second sensor 114 and the ECU 110 through the second cable 124, the first sensor 112 and the first cable 122. The signals are transmitted along the respective signal wires 140, 142 and through the respective connectors 162 of each of the sensors.

The third sensor 116 receives the second voltage, e.g. 5 volts, from the ECU 110 through the third cable 126. Signals can be transmitted over the signal wires 140, 142 to the third sensor 116 from the ECU 110 through the third cable 126. Signals S₃ can also be transmitted from the third sensor 116 to the ECU 110 through the third cable 126. The fourth sensor 118 receives the second voltage, e.g. 5, volts, from the ECU 110 through the third cable 126, the third sensor 116 and the fourth cable 128. Signals S₄ are transmitted along respective signal lines 140, 142 between the fourth sensor 118 and the ECU 110 through the third cable 126, the third sensor 116 and the fourth cable 128. The fifth sensor 120 receives the second voltage, e.g., 5 volts, from the ECU 110 through the third cable 126, the third sensor 116, the fourth cable 128, the fourth sensor 118 and the fifth cable 130. Signals S₅ are transmitted between the fifth sensor 120 and the ECU 110 through respective signal lines 140, 142 through the third cable 126, the third sensor 116, the fourth cable 128, the fourth sensor 118, and the fifth cable 130.

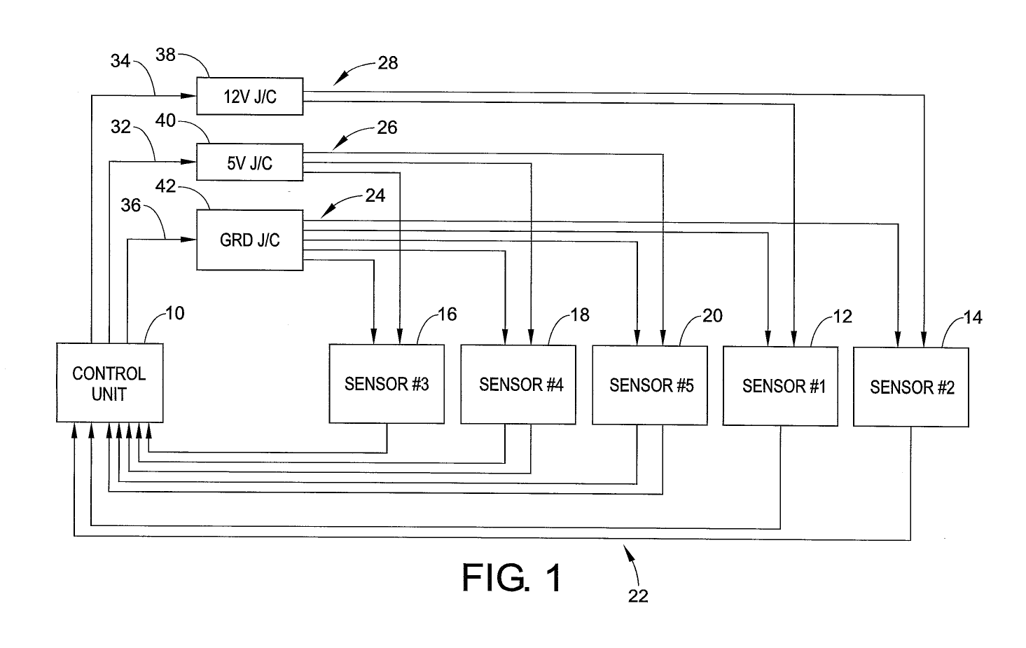

As seen when comparing the circuit arrangement of FIG. 1 to the circuit arrangement 100 shown in FIG. 2, the sensors 112, 114, 116, 118, and 120 connect with the ECU 110 in a daisy-chain arrangement with respect to power, ground and signal (data) transmission. This reduces the total wire length of the circuit arrangement shown in FIG. 2 as compared to the circuit arrangement shown in FIG. 1. Each of the sensors 112, 114, 116, 118, and 120 can be configured to output digital signals, as opposed to analog signals (e.g., voltage), which allows for common signal wires 140, 142 among the cables 122, 124, 126, 128 and 130. This can reduce costs due to a large amortization volume. Moreover, the joint connectors 38, 40, 42 required with the circuit arrangement depicted in FIG. 1 have been eliminated. Additionally, identical connectors 162 are found on each of the sensors 112, 114, 116, 118 and 120, which reduces assembly time and reduces part costs because of a large amortization volume. Additionally, the power wire 144 and the ground wire 146 are integrated into respective cables, which reduces the number of connectors found in the sensors 112, 114, 116, 118, 120 found in the circuit arrangement 100 depicted in FIG. 2, as compared to the circuit arrangement depicted in FIG. 1. Moreover, two-way communication between the ECU 110 and the respective sensors 112, 114, 116, 118, 120 is now possible. Furthermore, the respective ground wire 146 in each of the respective cables 122, 124, 126, 128, 130 wraps around the respective signal wires 140, 142 and the respective power wire 144, to shield the respective signal wires from electrical interference and noise.

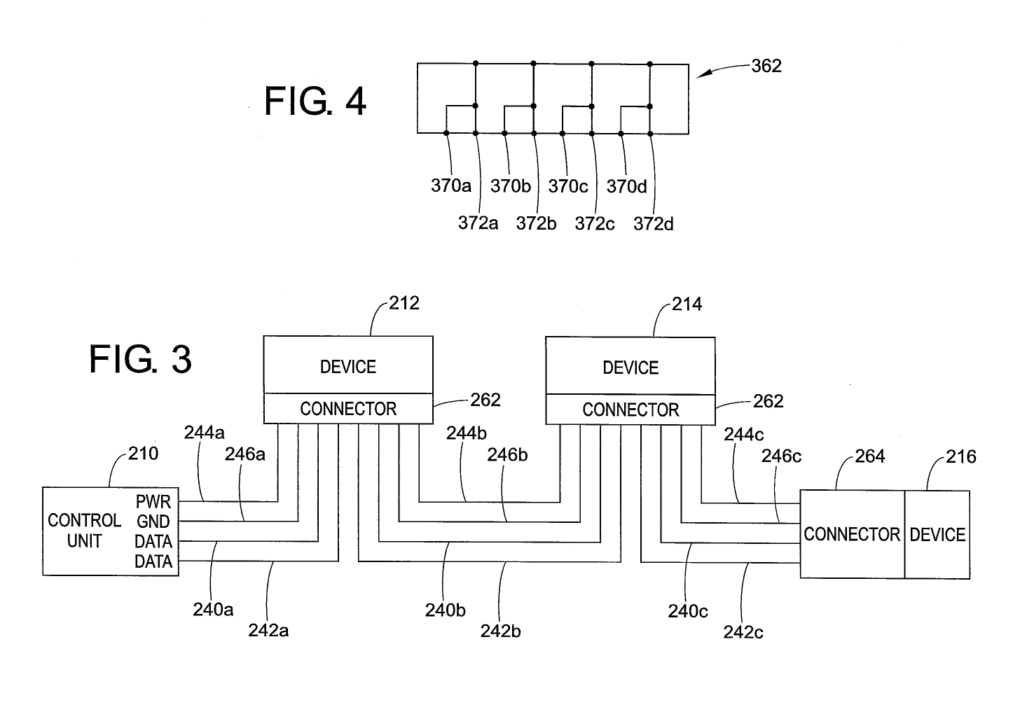

For the embodiment depicted in FIG. 2, the plurality of first sensors (or other devices) 112, 114 electrically connect with the ECU 110 in a daisy-chain arrangement with respect to power, ground and signal wires. Likewise, the plurality of second sensors (or devices) 116, 118, 120 electrically connect with the ECU 110 also in a daisy-chain arrangement with respect to power, ground and signal wires. In the embodiment depicted in FIG. 2, the power wire 144, the ground wire 146 and the signal wires 140, 142 are each found in a respective cable 122, 124, 126, 128, 130 used to connect the control unit 110 to the respective sensors 112, 114, 116, 118 and 120. FIG. 3 depicts an alternative configuration.

In FIG. 3, a control unit 210 connects to a plurality of devices 212, 214 and 216 (more devices can be provided) via a daisy chain connection with respect to power, ground and signal (data) lines. In this arrangement, the ground line includes a first ground wire 244a connecting the control unit 210 to the first device (sensor) 212, a second ground wire 244b connecting the first device 212 to the second device (sensor) 214, and a third ground wire 244c connecting the second device to a third device (sensor) 216. As also shown in FIG. 3, the power line includes a first power wire 246a connecting the control unit 210 to the first device 212, a second power wire 246b connecting the first device 212 to the second device 214, and a third power wire 246c connecting the second device to a third device 216.

As also shown in FIG. 3, the first signal line includes a signal wire 240a connecting the control unit 210 to the first device 212, a signal wire 240b connecting the first device 212 to the second device 214, and a signal wire 240c connecting the second device to a third device 216. The second signal line includes a signal wire 242a connecting the control unit 210 to the first device 212, a signal wire 242b connecting the first device 212 to the second device 214, and a signal wire 242c connecting the second device to a third device 216. Accordingly, the devices 212, 214 and 216 are connected with the ECU in a daisy chain arrangement with respect to power, ground and signal (data) transmission. Each of these devices 212, 214 and 216 operate at the same voltage. Another daisy chain arrangement could be provided to connect sensors that operate at another voltage.

The first device 212 and the second device 214 each include a respective connector 262 including eight terminals, one for each respective wire. The third device (or the final device) in the daisy chain arrangement includes a connector 264 having four terminals.

FIG. 4 depicts an alternative connector 362 including a plurality of terminals. The connector 362 can be used instead of connectors 262 or 264. The connector 362 includes a plurality of output terminals 370a, 370b, 370c and 370c and a plurality of input terminals 372a, 372b, 372c and 372d. For example, input terminal 372a can connect with a power wire to provide power to the respective sensor to which the terminal 362 is attached and output terminal 370a can connect with another power wire to provide power from the respective sensor to the next device in the daisy chain arrangement. Similarly, input terminal 372b can connect with a ground wire to provide ground to the respective sensor to which the terminal 362 is attached and output terminal 370a can connect with another ground wire to provide ground from the respective sensor to the next device in the daisy chain arrangement. Similarly, input terminal 372c can connect with a signal wire to provide data to the respective sensor to which the terminal 362 is attached and output terminal 370c can connect with another ground wire to provide data from the respective sensor to the next device in the daisy chain arrangement. Likewise, input terminal 372d can connect with a signal wire to provide data to the respective sensor to which the terminal 362 is attached and output terminal 370d can connect with another ground wire to provide data from the respective sensor to the next device in the daisy chain arrangement.

A method for providing power and transmitting signals is also disclosed. The method will be described with reference to FIG. 2 and the circuit arrangement 100 shown therein. Nevertheless, the method for providing power in transmitting signals could be used with other circuit arrangements.

The method includes electrically connecting via the first cable 122, the first engine sensor 112 to the vehicle ECU 110. The method further includes electrically connecting via the second cable 124 the second engine sensor 114 to the first engine sensor 112. As such, a daisy-chain configuration is provided for the first sensor 112 and the second sensor 114 with respect to the ECU 110.

The method for providing power in transmitting signals further includes providing a first voltage, e.g. 12 volts, to the first sensor 112 via the first cable 122. The method further includes providing the first voltage, e.g. 12 volts, to the second sensor 114 via the first cable 122, the first sensor 112 and the second cable 124. Since the first voltage is being provided to the second sensor 114 via the first cable 122, the first sensor 112, and the second cable 124, the joint connector 38, which is depicted in FIG. 1, can be eliminated.

The method for providing power and transmitting signals further includes transmitting signals between the first sensor 112 and the ECU 110 via the first cable 122. Signals can be transmitted along the signal wires 140, 142 of the first cable 122. The method further includes transmitting signals between the second sensor 114 and the ECU 110 via the first cable 122, the first sensor 112, and the second cable 124. The signals can be transmitted along the respective signal wires 140, 142 of the first cable 122 and the second cable 124 and through the respective connectors 162 of the first sensor 112.

The method for providing power and transmitting signals further include electrically connecting via the third cable 126 the third engine sensor 116 to the ECU 110. The method further includes electrically connecting via the fourth cable 128 the fourth engine sensor 118 to the third engine sensor 116. The method further includes electrically connecting via the fifth cable 130 the fifth engine sensor 120 to the fourth engine sensor 118. By connecting the fifth engine sensor 120 to the fourth engine sensor 118, and the fourth engine sensor 118 to the third engine sensor 116, which is directly connected with the ECU 110, the second plurality of engine sensors 116, 118 and 120 connect with the ECU 110 in a daisy-chain arrangement. As such, the joint connector 40, which is depicted in FIG. 1, can be eliminated in the circuit arrangement 100 depicted in FIG. 2.

The method for providing power and transmitting signals further includes providing a second voltage, which is different than the first voltage, to the third sensor 116 via the third cable 126. In the illustrated embodiment, the second voltage is 5 volts; however, the plurality of second sensors 116, 118 and 120 could operate at other voltages. The method further includes providing the second voltage to the fourth sensor 118 via the third cable 126, the third sensor 116 and the fourth cable 128. The method further includes providing the second voltage to the fifth sensor 120 via the third cable 126, the third sensor 116, the fourth cable 128, the fourth sensor 118 and the fifth cable 130. The second voltage can be provided to the fifth sensor via the third cable 126, the third sensor 116, the fourth cable 128, the fourth sensor 118, and the fifth cable 130, because of the daisy-chain arrangement. This reduces the total wire length of the circuit arrangement 100 depicted in FIG. 2 as compared to the circuit arrangement depicted in FIG. 1.

The method for providing power and transmitting signals further includes transmitting signals between the third sensor 116 and the ECU 110 via the third cable 126. These signals can be transmitted along the signal wires 140, 142 in the third cable. The method further includes transmitting signals between the fourth sensor 118 and the ECU 110 via the third cable 126, the third sensor 116 and the fourth cable 128. The method further includes transmitting signals between the fifth sensor 120 and the ECU 110 via the third cable 126, the third sensor 116, the fourth cable 128, the fourth sensor 118 and the fifth cable 130. The signals can be transmitted along the respective signal wires 140, 142 of the third cable 126, the fourth cable 128 and the fifth cable 130 as well as through the connectors 162.

A circuit arrangement, a vehicle system, and a method for providing power and transmitting signals has been described above with particularity. Modifications and alterations will occur to those upon reading and understanding the preceding detailed description. The invention, however, is not limited to only the embodiments described above. Instead, the invention is broadly defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A circuit arrangement comprising:
a vehicle ECU configured to control a fuel injection system of a vehicle engine;
a plurality of first sensors electrically connected with the ECU in a daisy-chain arrangement, each of the plurality of first sensors being configured to operate at a first voltage and to sense a respective vehicle engine condition; and
a plurality of second sensors electrically connected with the ECU in a daisy-chain arrangement, each of the plurality of second sensors being configured to operate at a second voltage, which is different than the first voltage, and to sense a respective vehicle engine condition.

2. The circuit arrangement of claim 1, wherein power from the ECU passes through at least one of the sensors of the plurality of first sensors to another of the sensors of the plurality of first sensors.

3. The circuit arrangement of claim 1, wherein at least one of the sensors in each of the plurality of first sensors and the plurality of second sensors includes a first connector and a second connector, which has an identical configuration to the first connector.

4. The circuit arrangement of claim 1, wherein electrical signals generated by at least one of the sensors in the plurality of first sensors passes through another of the sensors in the plurality of first sensors en route to the ECU.

5. The circuit arrangement of claim 4, wherein electrical signals generated by at least one of the sensors in the plurality of second sensors passes through another of the sensors in the plurality of second sensors en route to the ECU.

6. The circuit arrangement of claim 1, further comprising a plurality of cables connecting the sensors to the ECU, each cable including at least two respective signal wires, a respective power wire and a respective ground wire.

7. The circuit of claim 6, wherein each cable includes a respective terminal for connecting the respective cable to a respective sensor, wherein each sensor includes at least one connector configured to receive the terminal for connecting the respective cable to the respective sensor, wherein each connector is configured to accommodate the at least two respective signal wires, the respective power wire and the respective ground wire.

8. The circuit arrangement of claim 7, wherein at least one of the sensors in each of the plurality of first sensors and the plurality of second sensors includes a first connector and a second connector, which has an identical configuration to the first connector, wherein the first connector and the second connector are each configured to receive a respective terminal for connecting a respective cable to the respective sensor, wherein each connector is configured to accommodate the at least two respective signal wires, the respective power wire and the respective ground wire.

9. The circuit arrangement of claim 1, wherein for each cable the respective ground wire surrounds the respective signal wires and the respective power wire.

10. A vehicle system comprising:
a vehicle ECU configured to control a fuel injection system of a vehicle engine;
a first cable connected with the ECU;
a first sensor connected with the first cable and configured to operate at a first voltage and to sense a first vehicle engine condition;
a second cable connected with the first sensor;
a second sensor connected with the second cable and configured to operate at the first voltage and to sense a second vehicle engine condition;
a third cable connected with the ECU;
a third sensor connected with the third cable and configured to operate at a second voltage, which is different than the first voltage, and to sense a third vehicle engine condition;
a fourth cable connected with the third sensor; and
a fourth sensor connected with the fourth cable and configured to operate at the second voltage and to sense a fourth vehicle engine condition;
wherein each cable includes at least two respective signal wires, a respective power wire and a respective ground wire.

11. The vehicle system of claim 10, wherein the first sensor receives the first voltage from the ECU through the first cable, wherein signals are transmitted to the first sensor from the ECU through the first cable and from the first sensor to the ECU through the first cable.

12. The vehicle system of claim 10, wherein the second sensor receives the first voltage from the ECU through the first cable, the first sensor and the second cable, wherein signals are transmitted between the second sensor and the ECU through the second cable, the first sensor and the first cable.

13. The vehicle system of claim 10, wherein the third sensor receives the second voltage from the ECU through the third cable, wherein signals are transmitted to the third sensor from the ECU through the third cable and from the third sensor to the ECU through the third cable.

14. The vehicle system of claim 13, wherein the fourth sensor receives the second voltage from the ECU through the third cable, the third sensor and the fourth cable, wherein signals are transmitted between the fourth sensor and the ECU through the third cable, the third sensor and the fourth cable.

15. The vehicle system of claim 10, further comprising:
a fifth cable connected with the fourth sensor, wherein the fifth cable includes at least two respective signal wires, a respective power wire and a respective ground wire; and
a fifth sensor connected with the fifth cable and configured to operate at the second voltage and to sense a fifth vehicle engine condition.

16. The vehicle system of claim 10, wherein the respective ground wire surrounds the respective signal wires and the respective power wire for each cable along a majority of a length of the cable, and a protective sheath surrounds each of the wires.

17. The circuit of claim 16, wherein each cable includes a respective terminal for connecting the respective cable to a respective sensor, wherein each sensor includes at least one connector configured to receive the terminal for connecting the respective cable to the respective sensor, wherein each connector is configured to accommodate the at least two respective signal wires, the respective power wire and the respective ground wire.

18. The circuit arrangement of claim 17, wherein at least one of the sensors includes a first connector and a second connector, which has an identical configuration to the first connector, wherein the first connector and the second connector are each configured to receive a respective terminal for connecting a respective cable to the respective sensor, wherein each connector is configured to accommodate the at least two respective signal wires, the respective power wire and the respective ground wire.

19. A method for providing power and transmitting signals comprising:
electrically connecting via a first cable a first engine sensor to a vehicle ECU;
electrically connecting via a second cable a second engine sensor to the first engine sensor;
providing a first voltage to the first sensor via the first cable;
providing the first voltage to the second sensor via the first cable, the first sensor and the second cable;
transmitting signals between the first sensor and the ECU via the first cable;
transmitting signals between the second sensor and the ECU via the first cable, the first sensor and the second cable;
electrically connecting via a third cable a third engine sensor to the ECU;
electrically connecting via a fourth cable a fourth engine sensor to the third engine sensor;
providing a second voltage, which is different than the first voltage, to the third sensor via the third cable;
providing the second voltage to the fourth sensor via the third cable, the third sensor and the fourth cable;
transmitting signals between the third sensor and the ECU via the third cable; and
transmitting signals between the fourth sensor and the ECU via the third cable, the third sensor and the fourth cable.

20. The method of claim 19, further comprising:
electrically connecting via a fifth cable a fifth engine sensor to the fourth engine sensor;
providing the second voltage to the fifth sensor via the third cable, the third sensor, the fourth cable, the fourth sensor and the fifth cable; and
transmitting signals between the fifth sensor and the ECU via the third cable, the third sensor, the fourth cable, the fourth sensor and the fifth cable.
